(19) United States
(12) Patent Application Publication
(10) Pub. No.: US 2022/0342851 A1
(43) Pub. Date: Oct. 27, 2022

(54) FILE SYSTEM EVENT MONITORING USING METADATA SNAPSHOTS

(71) Applicant: VMware, Inc., Palo Alto, CA (US)

(72) Inventors: Pranay Singh, Palo Alto, CA (US); Wenguang Wang, Palo Alto, CA (US); Nitin Rastogi, Palo Alto, CA (US)

(73) Assignee: VMware, Inc., Palo Alto, CA (US)

(21) Appl. No.: 17/239,171

(22) Filed: Apr. 23, 2021

(51) Int. Cl. G06F 16/17; G06F 16/11; G06F 9/455

(52) U.S. Cl. CPC G06F 16/1734; G06F 16/128; G06F 9/45558; G06F 2009/45562

(57) ABSTRACT

The present disclosure is related to methods, systems, and machine-readable media for file system event monitoring using metadata snapshots. A traditional snapshot of a virtual computing instance (VCI) can be created in a file system. The snapshot can correspond to an extent. An indication can be made that the extent is owned by a single snapshot. A metadata snapshot, corresponding to the extent, can be created without changing the indication that the extent is owned. The extent can be modified, wherein the indication that the extent is owned causes the extent to be modified without allocating a new extent.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Snapshots may be utilized in a software defined data center to provide backups and/or disaster recovery. For instance, a snapshot can be used to revert to a previous version or state of a VCI. Some approaches may utilize snapshots for file system event monitoring and/or event collection. However, the impracticability associated with deleting old data pointed to by snapshots renders their space usage undesirably high for this purpose.

### BRIEF DESCRIPTION OF THE DRAWINGS

FIG. 1 is a diagram of a host and a system for file system event monitoring using metadata snapshots according to one or more embodiments of the present disclosure.

FIG. 2A illustrates an example file system B-tree according to one or more embodiments of the present disclosure at a first time instance.

FIG. 2B illustrates the example file system B-tree at a second time instance.

FIG. 3 illustrates two example file system B-trees, each belonging to a snapshot of a given VDFS sub-volume according to one or more embodiments of the present disclosure.

FIG. 4 is a diagram of a system for file system event monitoring using metadata snapshots according to one or more embodiments of the present disclosure.

FIG. 5 is a diagram of a machine for file system event monitoring using metadata snapshots according to one or more embodiments of the present disclosure.

FIG. 6 is a flow chart illustrating one or more methods for file system event monitoring using metadata snapshots according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

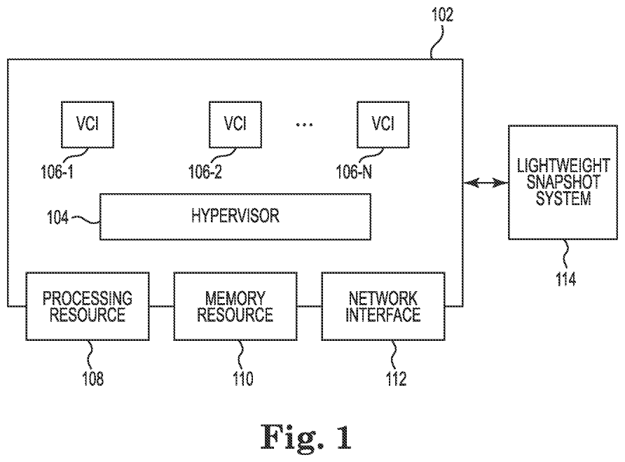

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

A VCI snapshot (alternatively referred to herein as “snapshot,” “traditional snapshot,” and/or “snapshot including extents”) is a copy of a disk file of a VCI at a given point in time. A snapshot can preserve the state of a VCI so that it can be reverted to at a later point in time. A snapshot corresponds to one or more extents. An extent is a contiguous area of storage reserved for a file in a file system. An extent can be represented, for instance, as a range of block numbers. Stated differently, an extent can include one or more data blocks that store data. As discussed further below, in some cases a single snapshot can “own” an extent. In other cases, more than one snapshot can “share” an extent. Stated differently, more than one snapshot can own an extent.

As previously discussed, traditional snapshots can be utilized for file system event collection (alternatively referred to herein as “file system event monitoring”). For instance, if a user wants to know whether a file, directory, and/or extended attribute has changed, two snapshots from different points in time can be compared (e.g., using a diff operation). However, snapshots are not particularly suited for this purpose due to their large space overhead. Due to the nature of snapshots (discussed further below) old data pointed to by a snapshot may not be able to be deleted and space usage of the file system can increase dramatically.

The present disclosure includes embodiments directed to a “lightweight snapshot” (also referred to herein as a “metadata snapshot”). Lightweight snapshots can be used to determine file system metadata changes while avoiding the space overhead issues associated with traditional snapshots. For instance, lightweight snapshots can be used for file system event monitoring while avoiding the space overhead issues associated with traditional snapshots. As referred to herein, a lightweight snapshot is a kind of snapshot that preserves metadata of a file system (e.g., files, directories, attributes) but does not prevent data from being saved like traditional snapshots do. Lightweight snapshots can correspond to (e.g., reference) an extent without “owning” that extent.

In addition to file system event monitoring, lightweight snapshots can provide space saving after a traditional snapshot has been used for disaster recovery. For instance, after a traditional snapshot's data has been copied over to a disaster recovery site (e.g., via a replication or backup application) the traditional snapshot can be converted to a lightweight snapshot. A lightweight snapshot converted from a traditional snapshot can be retained—as a matter of course in the disaster recovery process—as a reference, but does not carry with it the comparatively large amount of data that the traditional snapshot would. In addition to file system event monitoring, lightweight snapshots can be used to detect which files have been added and/or modified since a last backup in a backup service (e.g., a dropbox-like backup service) and backup the changed or added files. Additionally, antivirus services can utilize lightweight snapshots to determine which files have been added and/or modified since the last virus scan and save time by limiting scans to those files that have been added or modified.

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for file system event monitoring using metadata snapshots according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a lightweight snapshot system 114. An example of the lightweight snapshot system is illustrated and described in more detail below. In some embodiments, the lightweight snapshot system 114 can be a server, such as a web server.

A Virtual Distributed File System (VDFS) is a hyper converged distributed file system. In such a system, and in other systems, file system event monitoring is utilized in various application programming interfaces (APIs). For instance, antivirus programs can search new files for viruses, search engine indexers can read newly-added files to index their content or remove an index belonging to deleted files, and data analytic applications can read newly-changed files to update metrics such as “most accessed files.” However, current file system event monitoring approaches have limitations that make them unsuitable for large-scale file systems like VDFS. One limitation is that existing file system event APIs run at the guest operating system (OS) level and require the client to run inside the OS to monitor file system changes. VDFS runs at the hypervisor level and it allows multiple clients to connect to it from different VCIs. This makes any strategy for monitoring file system events inside the VCIs awkward because not only does the monitoring process need to run inside the VCI and send the events to VDFS, but different events from different VCIs need to be merged to get the overall events stream. Moreover, since a VCI may crash, it may lose the events collected after the changes to the file system have reached VDFS.

Another limitation is that there can be a high volume of file system events generated by certain workloads which may cause overflow and some events to be lost. Once this happens, a full file system rescan may be needed to start over, which is slow to handle. Another limitation is the overhead of real-time collection. Current file system events APIs allow real-time events collection in an order that they occurred. However, for VDFS use cases, real-time collection may be unnecessary because the order of the events may not matter and many files may live for only a few seconds before they are deleted. Another limitation is unbounded space usage. Current file system event APIs typically store events in the form of logs, which grow indefinitely over time.

One manner of addressing all of the above problems is to use traditional file system snapshots, as discussed above. VDFS uses a copy-on-write (CoW) B-tree to support scalable snapshots. Snapshots can be created instantaneously and there is no architecture limit of the maximum number of snapshots. VDFS also provides an efficient API to calculate what files and directories on a file system have changed since a past snapshot. Because the order of the file system events do not matter, the snapshot diff acts as the “file system event log” and can satisfy VDFS use cases of file system events.

A snapshot can be considered a copy of a file-share (sub-volume) as it preserves data and metadata for the entire file-share, so one can create a point in time read-only image of the file system. Many sub-volumes can be created in a single VDFS volume.

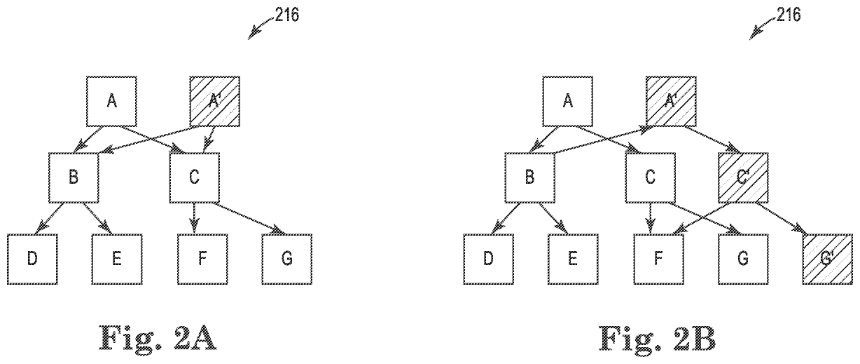

FIG. 2A illustrates an example file system B-tree 216 according to one or more embodiments of the present disclosure at a first time instance. FIG. 2B illustrates the example file system B-tree 216 at a second time instance. FIGS. 2A and 2B may be cumulatively referred to herein as “FIG. 2.” As shown in FIG. 2, the B-tree 216 includes an old root node A and new root node A′. The latest version of the file system (e.g., new writes) would point to root node A′, whereas the older root node A would be pointed to by snapshot. A live sub-volume represents the share of the file system where files are created and deleted, whereas snapshots are accessed via a special directory “/.vdfs/snapshot/”. As new writes happen to the live sub-volume, the two B-trees start to differ. Thus, as shown in FIG. 2B, nodes C′ and G′ have been added as child nodes of root node A′.

Snapshots can be used to support backup, replication, and local data protection, which involves storing older versions of the data in snapshots. As previously discussed, snapshots can be taken periodically to allow file system event monitoring, but do not allow old data to be deleted. A lightweight snapshot according to the present disclosure is a kind of snapshot that preserves metadata of a file share (e.g., files, directories, attributes) using a CoW B-tree but does not keep the old data from being deleted.

Because lightweight snapshots also use CoW B-tree, as the live sub-volume change, the B-tree of the live sub-volume and the lightweight snapshot starts to differ. At most, the file system B-tree will be completely copied so the maximum space overhead of a lightweight snapshot is the total size of the file system B-tree. The total size of the file system B-tree is usually a small proportion of the overall space. The same snapshot diff API used for traditional snapshots can be used to detect which files and directories have changed since the previous lightweight snapshot.

VDFS internally stores the namespace of a file-share (sub-volume) using a B+tree data structure, taking a snapshot of the file-share involves CoW (copy on write) operation on a B+tree, which involves a technique of lazy refcounting to avoid an update storm that leads to write amplification. Embedded refcounting of data blocks (e.g., extent(s)) that are shared between two neighboring snapshots (or a snapshot and a live sub-volume) can be employed to provide locality of reference count and reduce write amplification.

There are several applications that involve recording filesystem events, and lightweight snapshots in accordance with the present disclosure can be used to detect the filesystem events. As discussed above, lightweight snapshots provide a point in time image of the file share, so if lightweight snapshots are taken periodically on the same file share, the file system operations can be found by doing a diff of the snapshot B-tree.

Lightweight snapshots according to the present disclosure provide resolutions for problems posed by current file system events collection methods. For instance, collection of events-related information is happening at the file system layer itself, offering reliability and correctness. Further, since collected information persists like other inputs or outputs (TO), loss of information is reduced and durability is greatly increased. In addition, lightweight snapshots allow embodiments herein to simply work with the metadata of the file system without holding on to the data. Since metadata is a small fraction of the total file system, space usage is constrained and efficient. In accordance with embodiments herein, data does not need to be preserved to detect file system events and thus space usage can be reduced.

A traditional snapshot will reference extents (data blocks) by file as a part of file block map. A typical use of snapshot diff would be to track file objects that have changed between two snapshots. There are some applications which do not require a snapshot including extents, but are concerned with what has changed in a file system namespace besides extents.

If a user wants to know which file(s), director(ies) and extended attribute(s) may have changed, and is unconcerned with any extents that are associated with these file objects, a lightweight snapshot in accordance with the present disclosure serves the purpose. Lightweight snapshots record events like new file creation or modification of existing file or directory and utilize less space than traditional snapshots. Since extents are not “owned” by lightweight snapshots, an overwrite extent fragmentation makes an overwrite much cheaper as compared to an overwrite for a traditional snapshot.

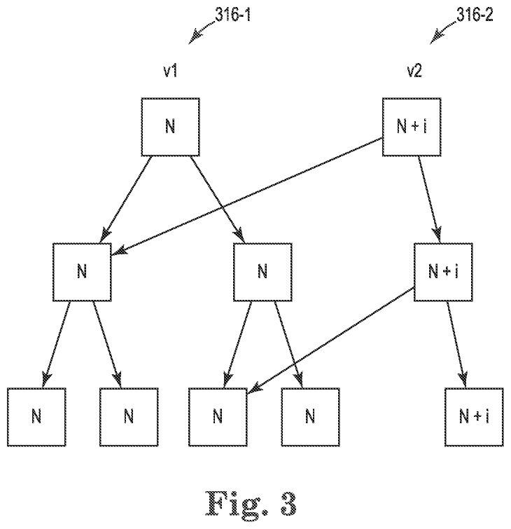

FIG. 3 illustrates two example file system B-trees, each belonging to a snapshot of a given VDFS sub-volume according to one or more embodiments of the present disclosure. The file system B-trees illustrated in FIG. 3 are a first tree 316-1 and a second tree 316-2. The first tree 316-1 may be alternatively referred to as “snapshot 1” and the second tree 316-2 may be alternatively referred to as “snapshot 2.” In FIG. 3, squares represent the page/node of the B-tree and the label on each page is a pagestamp (e.g., a monotonically increasing pagestamp) associated with that page. B-tree implementation enforces the fact that pagestamps of internal and leaf nodes cannot be greater than the root of the B-tree.

A B-tree diff involves traversing internal nodes that differ to determine the file objects (e.g., files, directories, extended attributes, extents, etc.) that have been changed between file system B-trees belonging to the two snapshots: snapshot 1 and snapshot 2. Snap-diff implementation for lightweight snapshots utilizes the pagestamp relationship to identify the shared pages between two snapshots and simply omits (e.g., ignores) them from diff s perspective. For instance, as shown in FIG. 3, root stamp of first tree 316-1 is N and root stamp of second tree 316-2 is N+i. N+i is greater than or equal to N. For a snap-diff processing between these B-trees, pages with stamps less than or equal to N are ignored as those pages are shared between the two B-trees. This approach reduces the number of pages that need to be compared for a diff processing. A brief pseudocode of the algorithm is presented below.

```
DiffFor Events(snapId1, snapId2)
{
  snapId1 is root stamp of first snapshot
  snapId2 is root stamp of second snapshot
  if (snapId1 == snapId2 || snapId2 < snapId1) {
    return;
  }
  snapId1Iterator = Iterator(snapId1)
  snapId2Iterator = Iterator(snapId2)
  while (snapId2Iterator) {
    pagestamp = GetStamp(snapId2Iterator)
    if (pagestamp < snapId2) {
      continue;
    }
    Get objectId from snapId2Iterator
    Find objectId in snapId1, compare and record events
  }
}
```

Lightweight snapshots in VDFS can share a common code path with traditional snapshots. In order to support lightweight snapshots, embodiments herein can distinguish a traditional snapshot from a lightweight snapshot. Stated differently, a different snapshot state is introduced in VDFS that differentiates a lightweight snapshot from a regular snapshot. This snapshot state may be indicated for each snapshot (traditional and lightweight) and may be referred to as a “snapshot type identifier.” Snapshot type identifiers can be one or more bits that indicate whether a snapshot is a traditional snapshot type or a lightweight (e.g., metadata) snapshot type.

For traditional snapshots, VDFS uses lazy reference counting of file system B-tree and embedded reference counting to track the ownership of data blocks. The embedded reference count is a shared bit per extent (variable size data block) that tracks the ownership of an extent together with the page stamping of the node. Thus, the same extent may be considered shared (e.g., owned by more than one snapshot) when read by one snapshot and owned (e.g., owned by a single snapshot) when read by a different snapshot. In some embodiments, the value of shared bit 0 (e.g., refcount 0) represents owner access and shared bit 1 represents shared access. If the snapshot Id of the root node and the leaf node is the same, the shared bit is unchanged, but if the snapshot Id is greater than the pagestamp of the leaf node, the shared bit will have a value of 1, representing shared access.

Ownership of an extent in traditional snapshots can be indicated by a shared bit value of “0” and sharing of an extent in traditional snapshots can be indicated by a shared bit value of “1.”. This shared bit is used by the live sub-volume to determine whether the extent can be written, or if a new extent allocation is required during overwrite. Each node is stamped with a snapshot Id. This scheme of ownership of extent is based on the fact that if the root node of the file system B-tree is the same as the leaf node of the file system B-tree, the root node and the leaf node were updated and/or created with the same snapshot Id, and are therefore of the same generation. However, if the stamping (snapshot Id) of the leaf node and the root node differ, the root node and the leaf node of the B-Tree are of different generations. If so, the B-tree does not own the extents, but has shared access. Thus, any potential overwrite would include the allocation of a new extent. Stated differently, if an extent is modified, an indication that the extent is owned causes the extent to be modified without allocating a new extent. If an extent is modified, an indication that the extent is shared causes a new extent to be allocated.

This logic of ownership is adjusted for lightweight snapshots, since lightweight snapshots do not own extents. The logic for lightweight snapshot needs to set the shared bit only if a regular snapshot is found between the snapshot Id of the leaf node and the snapshot Id of the root node. For instance, a regular snapshot can be searched from the snapshot Id of the leaf node to the snapshot Id of the root node, backwards. In other cases, the shared bit will be 0, which allows overwriting an extent in the live sub-volume. A brief pseudocode of the algorithm is presented below.

```
GetSharedBit(leafNode, rootNode)
{
  snapId1 is stamp of leafNode
  snapId2 is stamp of rootNode
  sharedBit = 0
    If (snapId == snapId2) {
      sharedBit = 0
    } else {
      SnapshotId = snapId2
      while (snapshotId > snapId1) {
        snapshotId = getprevSnapshot( )
      If (snapshotId is traditional Snapshot) {
      sharedBit = 1
      break;
    }
    }
  }
  Return sharedBit
}
```

Handling for a root leaf node is similar. A root leaf node occurs when the B-tree has just one node. In such cases, the current snapshot Id is checked. If the snapshot is a traditional snapshot, the shared bit is changed from 0 to 1 for each extent in the root leaf node. Alternatively, if the snapshot is a lightweight snapshot, the shared bit is not changed and it is passed unchanged from the current B-tree root leaf node to the successor B-tree root leaf node.

Embodiments herein can delete lightweight snapshots. As may be known to those of skill in the art, deleting a traditional snapshot can be considered a two-step process. The first step can be termed as “hollowing out,” wherein any extents that are owned by the traditional snapshot are deleted. The second step can involve deleting non-shared nodes of the B-tree. Stated differently, the second step can include deleting nodes with refcount of 1 that are part of the snapshot's B-tree. For lightweight snapshots, the first step can be omitted and the second step can be performed. That is, deleting a lightweight snapshot can include deleting non-shared nodes of the B-tree as lightweight snapshots exclude extents.

In addition to file system event monitoring, lightweight snapshots can provide space saving after a traditional snapshot is used for disaster recovery. For instance, after a traditional snapshot's data has been copied over to a disaster recovery site (e.g., via a replication or backup application) the traditional snapshot can be converted to a lightweight snapshot. A lightweight snapshot converted from a traditional snapshot can be retained—as a matter of course in the disaster recovery process—as a reference, but does not carry with it the unnecessary and/or duplicative data that the traditional snapshot would. A traditional snapshot can be converted into a lightweight snapshot by hollowing out the extents that are owned. Stated differently, a regular snapshot can be converted into a lightweight snapshot by performing the first step of snapshot deletion (discussed above) and omitting the second step.

Lightweight snapshots can be used by file analytics, Antivirus scanners, etc. Since file analytics may be an external component, and thus a different process, a number of APIs can be utilized for creation, deletion and listing of lightweight snapshots. For instance, lightweight snapshot can be created by remote procedure call (RPC), and can be marked as lightweight and persisted on disk. Lightweight snapshots can be deleted by RPC. Lightweight snapshots can be listed by RPC. Lightweight snapshots may not be listed with traditional snapshots, which may involve filtering the lightweight snapshots from the snapshot listing.

Lightweight snapshots in accordance with the present disclosure can be used for different file system event monitoring functions. For instance, lightweight snapshots can be used for periodic scans that track the events on a file or directory including, for instance, files or directory creations, deletions, modifications, accesses, etc.) because repeated events to the same files or directory are naturally merged into the same lightweight snapshot. Periodic scans can include antivirus scans to determine which files have been created and/or modified since the last scan. Periodic scans can be performed to check file integrity. For instance, in some embodiments, lightweight snapshots are created at frequent intervals to calculate a rolling checksum on newly created and/or updated files, which can avoid computing a checksum during file writes. Periodic scans can be used to perform file system auditing. For instance, instead of logging events like creation, deletion, and/or updates to files, lightweight snapshots can be used as a cheaper alternative. Periodic scans can be used by search engines for indexing newly-created files and removing indexing of deleted files. A metadata comparison using lightweight snapshots can be used to fetch this information from a file system.

As previously, discussed, embodiments herein provide space reclamation by converting traditional snapshots to lightweight snapshots. Applications that use two traditional snapshots to do a snap-diff (B-tree differ) to determine what has changed between two traditional snapshots can be used to do a snap-diff between a lightweight snapshot and a traditional snapshot. Since the data of the traditional snapshot has already been copied to a remote location it is not of much use to keep the traditional snapshot around, except for reference. Some applications that can make use of this functionality are applications that perform archiving to the cloud and/or backup to a data recovery site or to remote replica using snapshot-based replication.

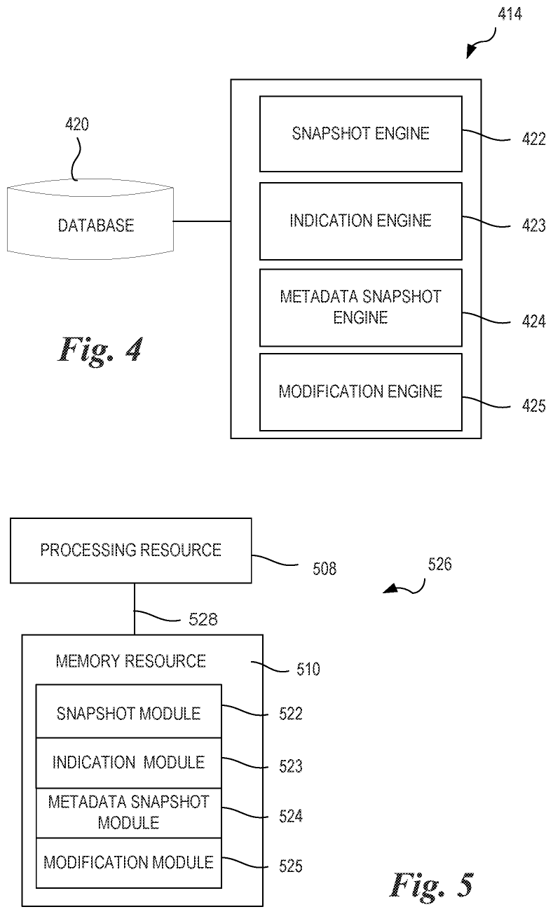

FIG. 4 is a diagram of a system 414 for file system event monitoring using metadata snapshots according to one or more embodiments of the present disclosure. The system 414 can include a database 420 and/or a number of engines, for example snapshot engine 422, indication engine 423, metadata snapshot engine 424 and/or modification engine 425, and can be in communication with the database 420 via a communication link. The system 414 can include additional or fewer engines than illustrated to perform the various functions described herein. The system can represent program instructions and/or hardware of a machine (e.g., machine 526 as referenced in FIG. 5, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the snapshot engine 422 can include a combination of hardware and program instructions that is configured to create a traditional snapshot of a virtual computing instance (VCI) in a file system, wherein the snapshot corresponds to an extent. In some embodiments, the indication engine 423 can include a combination of hardware and program instructions that is configured to indicate that the extent is owned by a single snapshot.

In some embodiments, the metadata snapshot engine 424 can include a combination of hardware and program instructions that is configured to create a metadata snapshot of the VCI in the file system, wherein the metadata snapshot corresponds to the extent, without changing the indication that the extent is owned. In some embodiments, the modification engine 425 can include a combination of hardware and program instructions that is configured to can include a combination of hardware and program instructions that is configured to modify the extent, wherein the indication that the extent is owned causes the extent to be modified without allocating a new extent.

FIG. 5 is a diagram of a machine for file system event monitoring using metadata snapshots according to one or more embodiments of the present disclosure. The machine 526 can utilize software, hardware, firmware, and/or logic to perform a number of functions. The machine 526 can be a combination of hardware and program instructions configured to perform a number of functions (e.g., actions). The hardware, for example, can include a number of processing resources 508 and a number of memory resources 510, such as a machine-readable medium (MRM) or other memory resources 510. The memory resources 510 can be internal and/or external to the machine 526 (e.g., the machine 526 can include internal memory resources and have access to external memory resources). In some embodiments, the machine 526 can be a VCI. The program instructions (e.g., machine-readable instructions (MRI)) can include instructions stored on the MRM to implement a particular function (e.g., an action such as creating a metadata snapshot). The set of MRI can be executable by one or more of the processing resources 508. The memory resources 510 can be coupled to the machine 526 in a wired and/or wireless manner. For example, the memory resources 510 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 510 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, non-volatile memory express (NVMe) drive, and/or a solid state drive (SSD), etc., as well as other types of machine-readable media.

The processing resources 508 can be coupled to the memory resources 510 via a communication path 528. The communication path 528 can be local or remote to the machine 526. Examples of a local communication path 528 can include an electronic bus internal to a machine, where the memory resources 510 are in communication with the processing resources 508 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 528 can be such that the memory resources 510 are remote from the processing resources 508, such as in a network connection between the memory resources 510 and the processing resources 508. That is, the communication path 528 can be a network connection. Examples of such a network connection can include a local area network (LAN), wide area network (WAN), personal area network (PAN), and the Internet, among others.

As shown in FIG. 5, the MM stored in the memory resources 510 can be segmented into a number of modules 522, 523, 524, 525 that when executed by the processing resources 508 can perform a number of functions. As used herein a module includes a set of instructions included to perform a particular task or action. The number of modules 522, 523, 524, 525 can be sub-modules of other modules. For example, the indication module 523 can be a sub-module of the snapshot module 522 and/or can be contained within a single module. Furthermore, the number of modules 522, 523, 524, 525 can comprise individual modules separate and distinct from one another. Examples are not limited to the specific modules 522, 523, 524, 525 illustrated in FIG. 5.

Each of the number of modules 522, 523, 524, 525 can include program instructions and/or a combination of hardware and program instructions that, when executed by a processing resource 508, can function as a corresponding engine as described with respect to FIG. 4. For example, the snapshot module 522 can include program instructions and/or a combination of hardware and program instructions that, when executed by a processing resource 508, can function as the snapshot engine 422, though embodiments of the present disclosure are not so limited.

The machine 526 can include a snapshot module 522, which can include instructions to create a traditional snapshot of a virtual computing instance (VCI) in a file system, wherein the snapshot corresponds to an extent. The machine 526 can include an indication module 523, which can include instructions to indicate that the extent is owned by a single snapshot. The machine 526 can include a metadata snapshot module 524, which can include instructions to create a metadata snapshot of the VCI in the file system, wherein the metadata snapshot corresponds to the extent, without changing the indication that the extent is owned. The machine 526 can include a modification module 525, which can include instructions to modify the extent, wherein the indication that the extent is owned causes the extent to be modified without allocating a new extent.

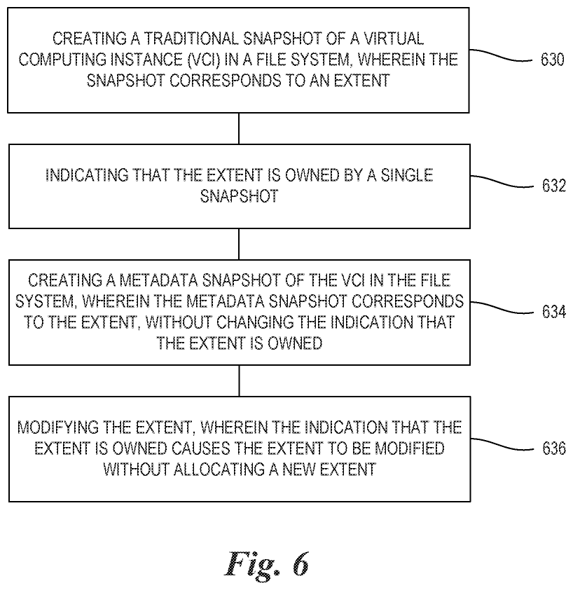

FIG. 6 is a flow chart illustrating one or more methods for file system event monitoring using metadata snapshots according to one or more embodiments of the present disclosure. At 630, the method can include creating a traditional snapshot of a virtual computing instance (VCI) in a file system, wherein the snapshot corresponds to an extent. At 632, the method can include indicating that the extent is owned by a single snapshot. At 634, the method can include creating a metadata snapshot of the VCI in the file system, wherein the metadata snapshot corresponds to the extent, without changing the indication that the extent is owned. At 636, the method can include modifying the extent, wherein the indication that the extent is owned causes the extent to be modified without allocating a new extent.

In some embodiments, the method can include creating a subsequent metadata snapshot, wherein the subsequent metadata snapshot corresponds to the modified extent, and performing a file system event monitoring function on portions of the file system that have been modified since a previous file system event monitoring function. The previous file system event monitoring function may have been performed after the creation of the metadata snapshot. As such, events occurring between the previous metadata snapshot and the metadata snapshot will include events that occurred since the previous file system event monitoring function. In an example, an antivirus scan may be limited to portions of the system that have been modified since the most recent antivirus scan, saving both time and computing resources. In some embodiments, the method can include determining the portions of the file system that have been modified since the previous file system event monitoring function by performing a comparison between the metadata snapshot and the subsequent metadata snapshot. Metadata in the subsequent metadata snapshot corresponding to a first file for which there was no metadata in the metadata snapshot indicates that the first file has been added since the metadata snapshot. Metadata in the metadata snapshot corresponding to a second file for which there is no metadata in the subsequent metadata snapshot indicates that the second file has been deleted since the metadata snapshot. Metadata corresponding to a third file in the metadata snapshot that is different than metadata corresponding to the third file in the subsequent metadata snapshot indicates that the third file has been edited.

In some embodiments, the method can include creating a second snapshot of the VCI in the file system, wherein the second snapshot corresponds to the modified extent and indicating that the extent is owned by more than one snapshot in response to both the snapshot and the second snapshot corresponding to the modified extent. In some embodiments, the method can include allocating a new extent comprising a further modified extent in response to the indication that the extent is owned by more than one snapshot and in response to a request to modify the modified extent.

In some embodiments, creating the snapshot includes setting a first snapshot type identifier to traditional snapshot type. In some embodiments, creating the snapshot includes setting a second snapshot type identifier to metadata snapshot type. In some embodiments, the method includes creating a second snapshot of the VCI in the file system, wherein the second snapshot corresponds to the modified extent, and wherein creating the second snapshot includes setting a third snapshot type identifier to traditional snapshot type, and indicating that the extent is shared in response to the type identifiers of both the snapshot and the second snapshot being traditional snapshot type.

In some embodiments, metadata snapshots can be converted from traditional snapshots. For instance, in some embodiments, the method can include allocating a new extent and converting the snapshot to a metadata snapshot by deleting the modified extent.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
creating a traditional snapshot of a virtual computing instance (VCI) in a file system, wherein the snapshot corresponds to an extent;
indicating that the extent is owned by a single snapshot;
creating a metadata snapshot of the VCI in the file system, wherein the metadata snapshot corresponds to the extent, without changing the indication that the extent is owned; and
modifying the extent, wherein the indication that the extent is owned causes the extent to be modified without allocating a new extent.

2. The method of claim 1, wherein the method includes:
creating a subsequent metadata snapshot, wherein the subsequent metadata snapshot corresponds to the modified extent; and
performing a file system event monitoring function on portions of the file system that have been modified since a previous file system event monitoring function, which was performed after the creation of the metadata snapshot, including:
determining the portions of the file system that have been modified since the previous file system event monitoring function by performing a comparison between the metadata snapshot and the subsequent metadata snapshot, wherein:
metadata in the subsequent metadata snapshot corresponding to a first file for which there was no metadata in the metadata snapshot indicates that the first file has been added since the metadata snapshot;
metadata in the metadata snapshot corresponding to a second file for which there is no metadata in the subsequent metadata snapshot indicates that the second file has been deleted since the metadata snapshot; and
metadata corresponding to a third file in the metadata snapshot that is different than metadata corresponding to the third file in the subsequent metadata snapshot indicates that the third file has been edited.

3. The method of claim 1, wherein the method includes:
creating a second snapshot of the VCI in the file system, wherein the second snapshot corresponds to the modified extent;
indicating that the extent is owned by more than one snapshot in response to both the snapshot and the second snapshot corresponding to the modified extent.

4. The method of claim 3, wherein the method includes allocating a new extent comprising a further modified extent in response to the indication that the extent is owned by more than one snapshot and in response to a request to modify the modified extent.

5. The method of claim 1, wherein:
creating the snapshot includes setting a first snapshot type identifier to traditional snapshot type; and
wherein creating the metadata snapshot includes setting a second snapshot type identifier to metadata snapshot type.

6. The method of claim 5, wherein the method includes:
creating a second snapshot of the VCI in the file system, wherein the second snapshot corresponds to the modified extent, and wherein creating the second snapshot includes setting a third snapshot type identifier to traditional snapshot type; and
indicating that the extent is shared in response to the type identifiers of both the snapshot and the second snapshot being traditional snapshot type.

7. The method of claim 1, wherein the method includes:
allocating a new extent; and
converting the snapshot to a metadata snapshot by deleting the modified extent.

8. A non-transitory machine-readable medium having instructions stored thereon which, when executed by a processor, cause the processor to:
create a traditional snapshot of a virtual computing instance (VCI) in a file system, wherein the snapshot corresponds to an extent;
indicate that the extent is owned by a single snapshot;
create a metadata snapshot of the VCI in the file system, wherein the metadata snapshot corresponds to the extent, without changing the indication that the extent is owned; and
modify the extent, wherein the indication that the extent is owned causes the extent to be modified without allocating a new extent.

9. The medium of claim 8, including instructions to:
create a subsequent metadata snapshot, wherein the subsequent metadata snapshot corresponds to the modified extent; and
perform a file system event monitoring function on portions of the file system that have been modified since a previous file system event monitoring function, which was performed after the creation of the metadata snapshot, including:
determining the portions of the file system that have been modified since the previous file system event monitoring function by performing a comparison between the metadata snapshot and the subsequent metadata snapshot, wherein:
metadata in the subsequent metadata snapshot corresponding to a first file for which there was no metadata in the metadata snapshot indicates that the first file has been added since the metadata snapshot;
metadata in the metadata snapshot corresponding to a second file for which there is no metadata in the subsequent metadata snapshot indicates that the second file has been deleted since the metadata snapshot; and
metadata corresponding to a third file in the metadata snapshot that is different than metadata corresponding to the third file in the subsequent metadata snapshot indicates that the third file has been edited.

10. The medium of claim 8, including instructions to:
create a second snapshot of the VCI in the file system, wherein the second snapshot corresponds to the modified extent;
indicate that the extent is owned by more than one snapshot in response to both the snapshot and the second snapshot corresponding to the modified extent.

11. The medium of claim 10, including instructions to allocate a new extent comprising a further modified extent in response to the indication that the extent is owned by more than one snapshot and in response to a request to modify the modified extent.

12. The medium of claim 8, wherein:
the instructions to create the snapshot include instructions to set a first snapshot type identifier to traditional snapshot type; and
the instructions to create the metadata snapshot include instructions to set a second snapshot type identifier to metadata snapshot type.

13. The medium of claim 12, including instructions to:
create a second snapshot of the VCI in the file system, wherein the second snapshot corresponds to the modified extent, and wherein creating the second snapshot includes setting a third snapshot type identifier to traditional snapshot type; and
indicate that the extent is shared in response to the type identifiers of both the snapshot and the second snapshot being traditional snapshot type.

14. The medium of claim 8, including instructions to:
allocate a new extent; and
convert the snapshot to a metadata snapshot by deleting the modified extent.

15. A system, comprising:
a snapshot engine configured to create a traditional snapshot of a virtual computing instance (VCI) in a file system, wherein the snapshot corresponds to an extent;
an indication engine configured to indicate that the extent is owned by a single snapshot;
a metadata snapshot engine configured to create a metadata snapshot of the VCI in the file system, wherein the metadata snapshot corresponds to the extent, without changing the indication that the extent is owned; and
a modification engine configured to modify the extent, wherein the indication that the extent is owned causes the extent to be modified without allocating a new extent.

16. The system of claim 15, including a subsequent metadata snapshot engine configured to:
create a subsequent metadata snapshot, wherein the subsequent metadata snapshot corresponds to the modified extent; and
perform a file system event monitoring function on portions of the file system that have been modified since a previous file system event monitoring function, which was performed after the creation of the metadata snapshot, including:
determining the portions of the file system that have been modified since the previous file system event monitoring function by performing a comparison between the metadata snapshot and the subsequent metadata snapshot, wherein:
metadata in the subsequent metadata snapshot corresponding to a first file for which there was no metadata in the metadata snapshot indicates that the first file has been added since the metadata snapshot;
metadata in the metadata snapshot corresponding to a second file for which there is no metadata in the subsequent metadata snapshot indicates that the second file has been deleted since the metadata snapshot; and
metadata corresponding to a third file in the metadata snapshot that is different than metadata corresponding to the third file in the subsequent metadata snapshot indicates that the third file has been edited.

17. The system of claim 15, including a second snapshot engine configured to:
create a second snapshot of the VCI in the file system, wherein the second snapshot corresponds to the modified extent; and
indicate that the extent is owned by more than one snapshot in response to both the snapshot and the second snapshot corresponding to the modified extent.

18. The system of claim 17, wherein the second snapshot engine is configured to allocate a new extent comprising a further modified extent in response to the indication that the extent is owned by more than one snapshot and in response to a request to modify the modified extent.

19. The system of claim 15, wherein:
the snapshot engine is configured to set a first snapshot type identifier to traditional snapshot type; and
the metadata snapshot engine is configured to set a second snapshot type identifier to metadata snapshot type.

20. The system of claim 19, including a second snapshot engine configured to:
create a second snapshot of the VCI in the file system, wherein the second snapshot corresponds to the modified extent, and wherein creating the second snapshot includes setting a third snapshot type identifier to traditional snapshot type; and
indicate that the extent is shared in response to the type identifiers of both the snapshot and the second snapshot being traditional snapshot type.
